(19) United States
(12) Patent Application Publication
(10) Pub. No.: US 2012/0257292 A1
(43) Pub. Date: Oct. 11, 2012

(54) Wafer Level Lens Module and Method for Manufacturing the Wafer Level Lens Module

(75) Inventor: Yin-Dong LU, Tainan City (TW)

(73) Assignee: HIMAX TECHNOLOGIES LIMITED, Tainan City (TW)

(21) Appl. No.: 13/082,582

(22) Filed: Apr. 8, 2011

(51) Int. Cl. G02B 7/02; B32B 37/26; B32B 37/12; B32B 37/02; B32B 37/06

(52) U.S. Cl. 359/819; 156/275.5

(57) ABSTRACT

A wafer level lens module which processes images includes a glass substrate, the metal baffle layers, a convex lens, and a concave lens. The glass substrate has a first surface and a second surface, and the metal baffle layers are respectively disposed on the first surface and the second surface of the glass substrate for blocking some light, in which each metal baffle layer comprises at least one through holes. The convex lens and the concave lens, disposed on the first surface or the second surface of the glass substrate, are contacted with the metal baffle layers.

### BACKGROUND

1. Field of Invention

The present invention relates to a wafer level lens. More particularly, the present invention relates to a wafer level lens adapted by the camera.

2. Description of Related Art

Miniaturized cameras are widely used in many electronic products, such as the mobile phones. Recently, the wafer level camera modules (WLCM) that includes a wafer-level lens module therein have been used to make such miniaturized cameras. The wafer level lens module is manufactured by arranging and stacking a plurality of transparent wafers, and each has polymer lenses formed in an array using a replica method, then cutting them. Accordingly, the wafer level lens module can be manufactured to be small, light, and low cost, which allows for mass production.

In addition, a WLCM usually defines a light incident hole to allow light to pass through the lenses, and the WLCM needs to be coated with the adhesive tape/film to shelter the remaining part beyond the light incident hole. However, if the adhesive tape/film is misaligned, some of the coating may be deposited on the selected lens area, which neither blocks the undesired light nor allows the pass for the desired light, and the image quality is harmed as a result.

Therefore, there is a need for a new wafer level lens module and a method for manufacturing it to improve the image quality.

### SUMMARY

According to one embodiment of the present invention, a wafer level lens module for processing images is disclosed, in which the wafer level lens module includes a glass substrate, two metal baffle layers, a convex lens, and a concave lens. The glass substrate has a first surface and a second surface. The metal baffle layers are respectively disposed on the first surface and the second surface of the glass substrate for blocking some light, in which each metal baffle layer includes at least one through hole. The convex lens, disposed on the first surface of the glass substrate, is contacted with one of the metal baffle layer. The concave lens, disposed on the second surface opposite to the first surface of the glass substrate, is contacted with the other metal baffle layer.

According to another embodiment of the present invention, a wafer level lens module for processing images is disclosed, in which the wafer level lens module includes a plurality of glass substrates, a plurality of space elements, a plurality of metal baffle layers, a plurality of convex lenses, and a plurality of concave lens. Each glass substrate has a first surface and a second surface, and the space elements are disposed on the glass substrates for spacing the glass substrates. The metal baffle layers are disposed on the first surfaces and the second surfaces of the glass substrates for blocking some light, in which each metal baffle layer includes at least one through hole. The convex lenses and the concave lens are disposed on the first surfaces or the second surfaces of the glass substrates, and they are contacted with the metal baffle layers.

According to the other embodiment of the present invention, a method for manufacturing a wafer level lens module is disclosed. The method provides one glass substrate having a first surface and a second surface opposite to the first substrate, and disposes one metal baffle layer comprising at least one through hole on the first surface of the glass substrate for blocking some light. The method also disposes the polymer glue on the first surface of the glass substrate, shapes the polymer glue to be a convex lens with a lens mould, and solidifies the shaped polymer glue to form the convex lens by exposing the shaped polymer glue to the ultraviolet (UV) rays.

It is to be understood that both the foregoing general description and the following detailed description are by examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a diagram of wafer level lens module according to one embodiment of the present invention;

FIG. 2A-FIG. 2H show the structure and the manufacturing method of the wafer level lens module according to one embodiment of the present invention; and

FIG. 3A and FIG. 3B show the cross-section view of the metal baffle layer according to one embodiment of the present invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The wafer level lens module of the following embodiment adapts the metal baffle layer to precisely and effectively block the undesired light such as the ghost image or the flare, which improves the image quality.

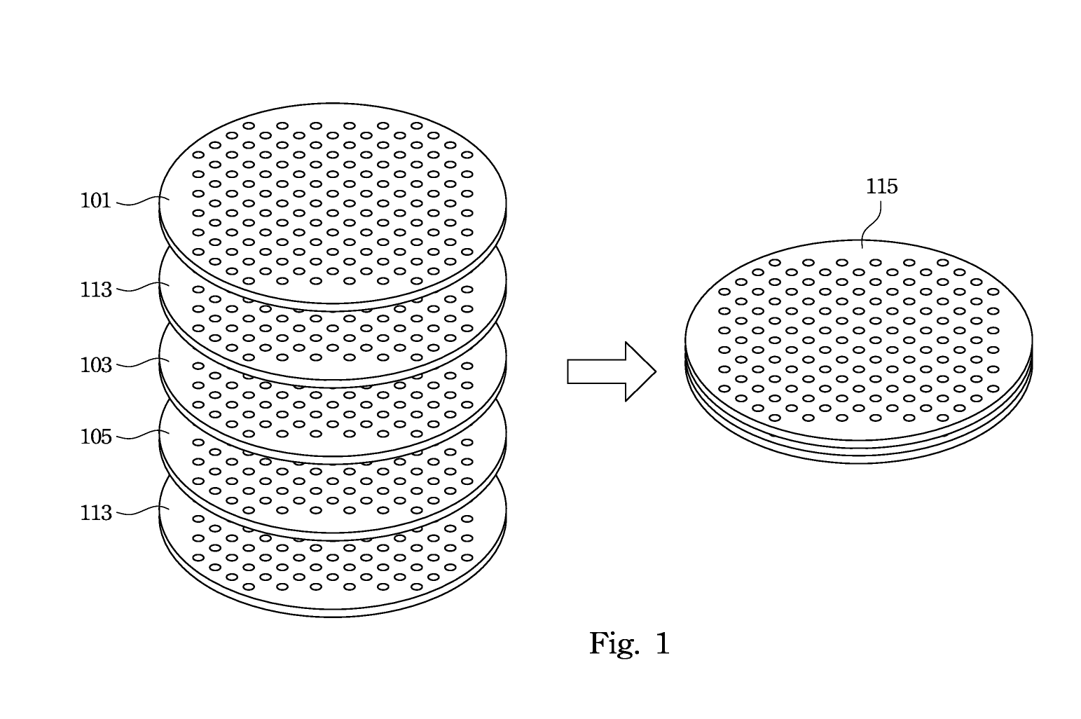

FIG. 1 is a diagram of wafer level lens module according to one embodiment of the present invention. As shown in FIG. 1, the glass substrate 101, the space element 113, the metal baffle layer 103, and the lens 105 are integrated into the wafer level lens module 115.

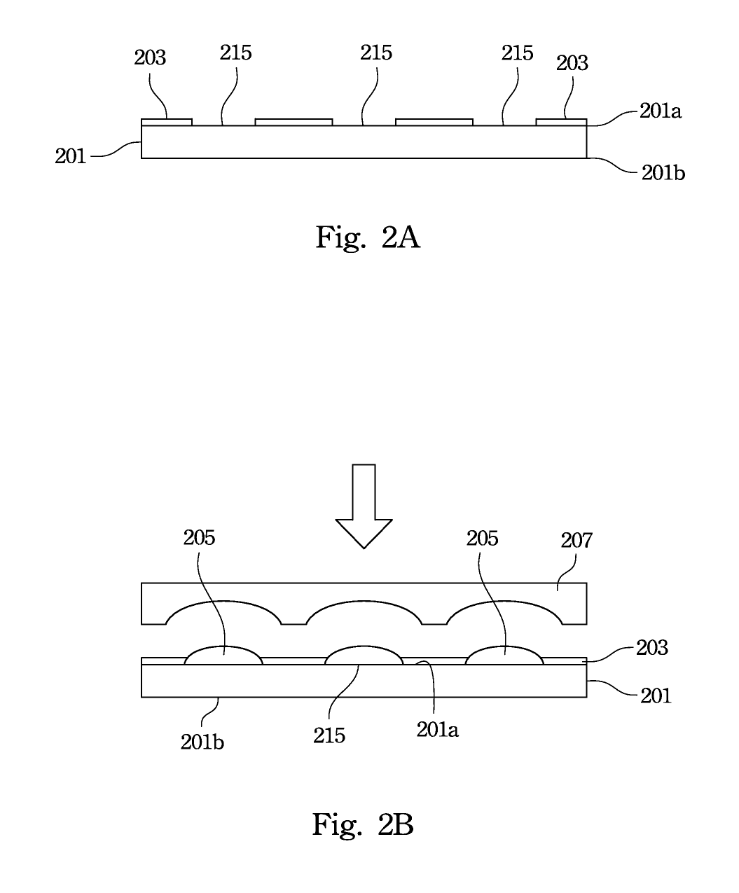

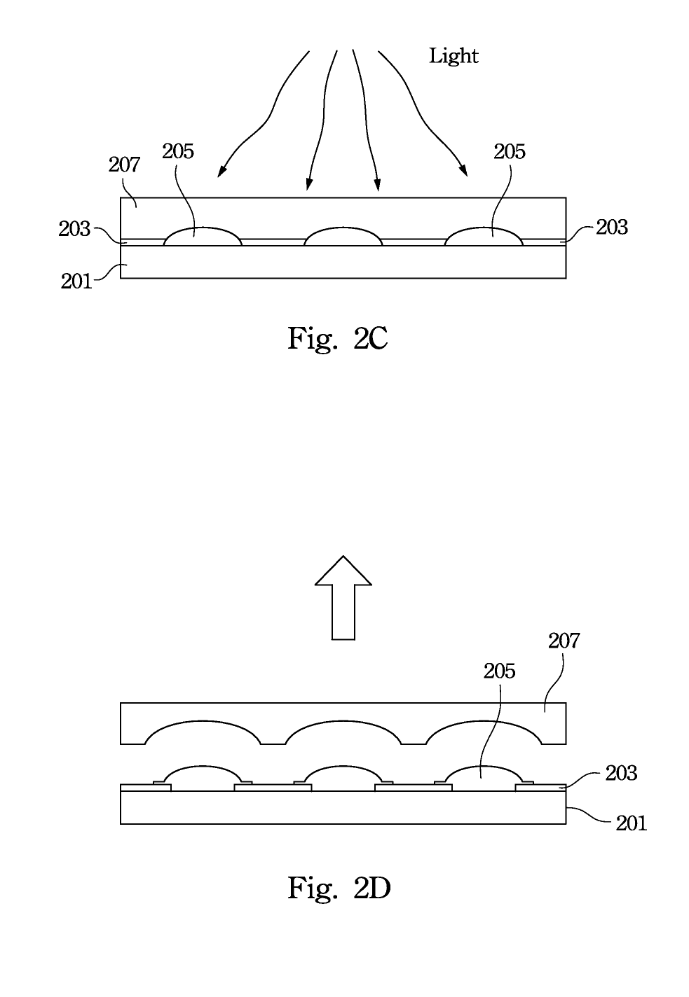

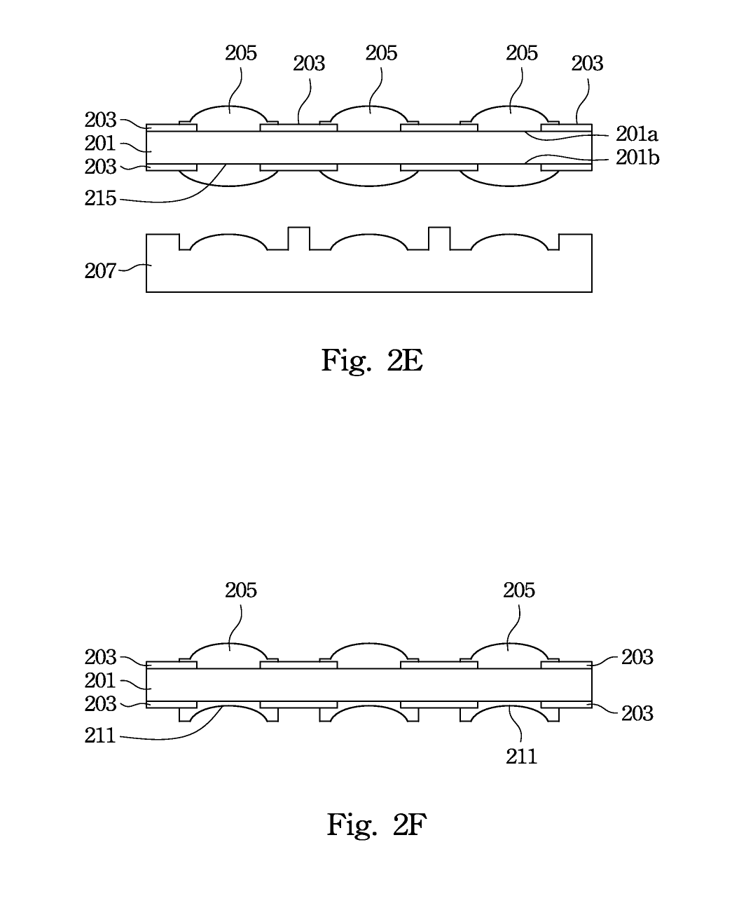

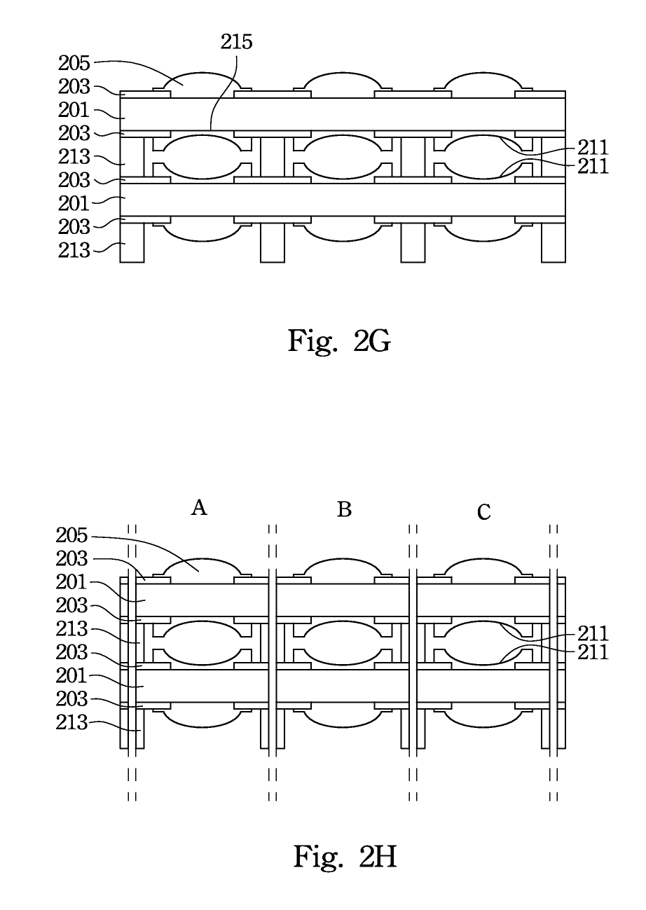

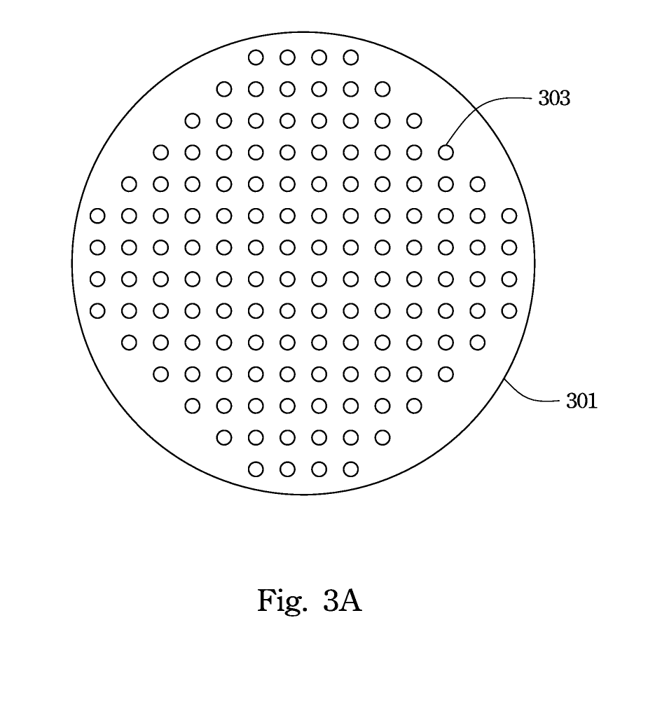

FIG. 2A-FIG. 2H show the structure and the manufacturing method of the wafer level lens module according to one embodiment of the present invention. In FIG. 2A, the glass substrate 201 having a first surface 201a and a second surface 201b opposite to the first substrate 201 is provided, and the metal baffle layer 203 includes the through holes 215 is disposed on the first surface 201a of the glass substrate 201 for blocking some light.

Specifically, the metal baffle layer 203 with a film attached upon are etched to generate the through hole. For example, the film might be first affixed to the raw metal baffle layer. Then, the film and the raw metal baffle layer are etched together by the chemicals to generate the through holes 215 on the metal baffle layer 203. Because the metal baffle layer 203 can be etched together with the wafer, the manufacturing process can be simplified.

After that, the polymer glue is disposed on the first surface 201a of the glass substrate 201 and shaped to be the convex lens 205 with the lens mould 207 as shown in FIG. 2B; in more detail, the through holes 215 of the metal baffle layer 203 are stuffed with the polymer glue that will become the convex lens 205. Then in FIG. 2C, the shaped polymer glue is solidified to form the rigid convex lens 205 contacted with the metal baffle layers 203 by exposing the shaped polymer glue to ultraviolet (UV) rays, and the lens mould 207 is moved away after the polymer glue is solidified to form the convex lens 205 as shown in FIG. 2D.

After the convex lens 205 is formed, the other metal baffle layer 203 including the through hole 215 is disposed on the second surface 201b opposite to the first surface 201a of the glass substrate 201 as shown in FIG. 2E, and polymer glue is once again disposed on the second surface 201b of the glass substrate 201. Next, the polymer glue on the second surface 201b is shaped to be a concave lens with another type of lens mould 207, and is solidified to form the concave lens 211 contacted with the other metal baffle layer 203 as shown in FIG. 2F.

Continuing to FIG. 2G, two glass substrates 201 having the convex lens 205 and the concave lens 211 are staked and spaced by the space element 213. Then in FIG. 2H, the staked glass substrates 201 and their convex lens 205 as well as the concave lens 211 are cut into individual wafer level lens module A/B/C as shown in FIG. 2H.

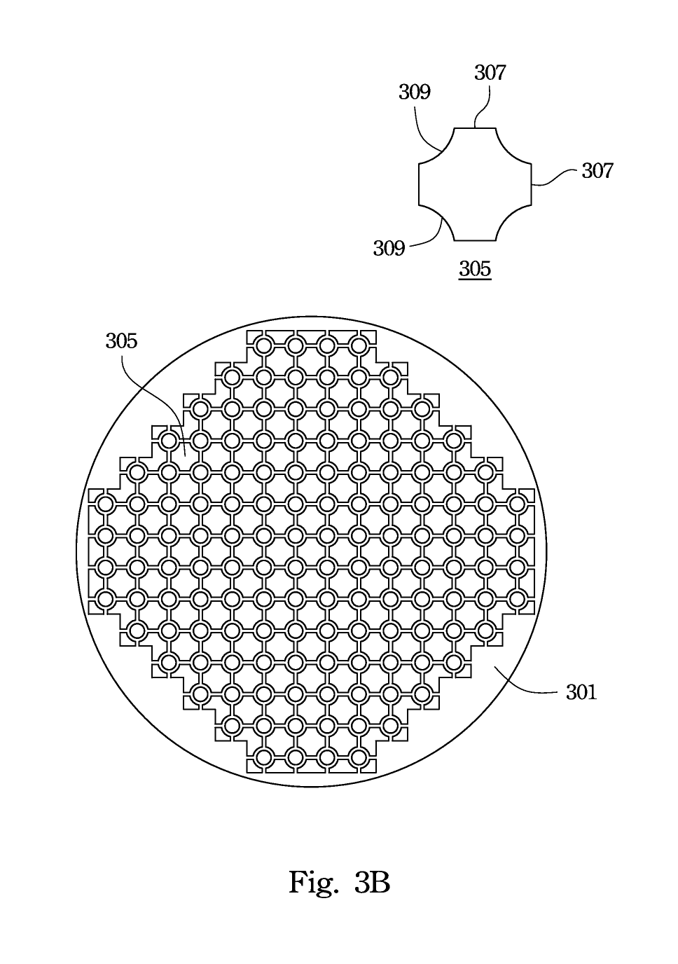

FIG. 3A and FIG. 3B shows the cross-section view of the metal baffle layer according to one embodiment of the present invention. The metal baffle layer 301 is made of metal and has the black color to shielding the undesired light, in which width of the metal baffle layer can be as thin as 0.02 um-0.03 um. Both the metal baffle layer shown in FIG. 3A and the metal baffle layer show in FIG. 3B, have through holes, however, these through holes are different in shape. More specifically, the lateral sections of the through holes 303 shown in FIG. 3A are circles, while the through holes 305 of the metal baffle layers 301 have the anomalous shape, that is, the through hole 305 of the metal baffle layers 301 shown in FIG. 3 B is surrounded by several arc sides 309 and several straight sides 307.

According to the above embodiment, the wafer level lens module adapting the metal baffle layer can shield the undesired light more precisely, which improves the image quality; more particularly, the metal baffle layer is thin enough to reduce the total size of the wafer level lens module.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A wafer level lens module for processing images, comprising:
a glass substrate having a first surface and a second surface;
two metal baffle layers respectively disposed on the first surface and the second surface of the glass substrate for blocking some light, wherein each metal baffle layer comprises at least one through hole;
a convex lens, disposed on the first surface of the glass substrate, contacted with one of the metal baffle layer; and
a concave lens, disposed on the second surface opposite to the first surface of the glass substrate, contacted with the other metal baffle layer.

2. The wafer level lens module as claimed in claim 1, wherein the through holes of the metal baffle layers are stuffed with the convex lens or the concave lens.

3. The wafer level lens module as claimed in claim 1, wherein lateral sections of the through holes are circles.

4. The wafer level lens module as claimed in claim 1, wherein each through hole of the metal baffle layers has an anomalous shape.

5. The wafer level lens module as claimed in claim 1, wherein each through hole of the metal baffle layers is surrounded by a plurality of arc sides and a plurality of straight sides.

6. A wafer level lens module for processing images, comprising:
a plurality of glass substrates, each glass substrate having a first surface and a second surface;
a plurality of space elements disposed on the glass substrates for spacing the glass substrates;
a plurality of metal baffle layers disposed on the first surfaces and the second surfaces of the glass substrates for blocking some light, wherein each metal baffle layer comprises at least one through holes;
a plurality of convex lenses, disposed on the first surfaces of the glass substrates, contacted with the metal baffle layers; and
a plurality of concave lens, disposed on the second surfaces opposite to the first surfaces of the glass substrates, contacted with other metal baffle layers.

7. The wafer level lens module as claimed in claimed 6, wherein the convex lenses face each other.

8. The wafer level lens module as claimed in claim 6, wherein the through holes of the metal baffle layers are stuffed with the convex lenses or the concave lenses.

9. The wafer level lens module as claimed in claim 6, wherein lateral sections of the through holes are circles.

10. The wafer level lens module as claimed in claim 6, wherein each through hole of the metal baffle layers has an anomalous shape.

11. The wafer level lens module as claimed in claim 6, wherein each through hole of the metal baffle layers is surrounded by a plurality of arc sides and a plurality of straight sides.

12. A method for manufacturing a wafer level lens module, comprising:
providing one glass substrate having a first surface and a second surface opposite to the first surface;
disposing one metal baffle layer comprising at least one through hole on the first surface of the glass substrate for blocking some light;
disposing polymer glue on the first surface of the glass substrate;
shaping the polymer glue to be a convex lens with a lens mould; and
solidifying the shaped polymer glue to form the convex lens by exposing the shaped polymer glue to ultraviolet (UV) rays.

13. The method for manufacturing the wafer level lens module as claimed in claim 12, wherein the polymer glue is stuffed into the through hole of the metal baffle layer.

14. The method for manufacturing the wafer level lens module as claimed in claim 12, wherein the metal baffle layer with a film attached upon are etched to generate the through hole.

15. The method for manufacturing the wafer level lens module as claimed in claim 12, further comprising:
disposing the other metal baffle layer comprising the through hole on the second surface of the glass substrate;
disposing the polymer glue on the second surface of the glass substrate; and
shaping the polymer glue as a concave lens with a lens mould.

16. The method for manufacturing a wafer level lens module as claimed in claim 12, further comprising stacking two glass substrates having the convex lens and the concave lens, wherein the glass substrates are spaced apart by space elements.
